(19) United States
(12) Patent Application Publication
(10) Pub. No.: US 2016/0266894 A1
(43) Pub. Date: Sep. 15, 2016

(54) SYSTEMS AND METHODS FOR LIVE UPGRADE AND UPDATE OF FIRMWARE ON AN EMBEDDED NETWORKING DEVICE

(71) Applicant: CAVIUM, INC., San Jose, CA (US)

(72) Inventors: Manojkumar Panicker, Sunnyvale, CA (US); Derek Chickles, San Jose, CA (US); Faisal Masood, San Jose, CA (US); Ramarao Kopparthi, Hydearabad (IN); Satish Kikkeri, San Jose, CA (US); Parasun Kapoor, Fremont, CA (US); David Daney, San Jose, CA (US); Leonid Rosenboim, Los Gatos, CA (US)

(21) Appl. No.: 15/067,050

(22) Filed: Mar. 10, 2016

Related U.S. Application Data
(60) Provisional application No. 62/131,776, filed on Mar. 11, 2015.

(51) Int. Cl. G06F 9/445; H04L 29/08

(52) U.S. Cl. CPC G06F 8/67; H04L 67/34

(57) ABSTRACT

A new approach is proposed that contemplates systems and methods to support performing a live update or upgrade of a firmware of an embedded networking device to a successful completion without resetting the embedded networking device. For the live update or upgrade to the firmware of the embedded networking device, a new version of the firmware that includes new features/enhancements to improve the product functionality or fix bugs encountered in previous versions of the firmware is installed seamlessly on the embedded networking device to replace the current version of the firmware on one or more cores at a time. During the live firmware updating or upgrading process, various software applications running on other cores of the embedded networking device continue to perform packet processing operations without any interruption. The live firmware update process continues until all cores of the embedded networking device are updated with the newly updated/upgraded firmware.

### CROSS-REFERENCE TO RELATED APPLICATIONS

This application claims the benefit of United States Provisional Patent Application No. 62/131,776, filed Mar. 11, 2015, and entitled “Live upgrade/update of firmware on an embedded networking device with multicore processor,” which is incorporated herein in its entirety by reference.

### BACKGROUND

An embedded networking device such as a Network Interface Card (NIC) often includes a multi-core network packet processing engine, which can support and allow for flexible packet processing at various I/O rates (e.g., 10, 25, and 40 Gbps). Such flexible packet processing requires application software running on the multi-core network packet processing engine to be updated or upgraded frequently to provide the corresponding packet processing capabilities with support from the underlying hardware platform.

The generic way to upgrade or update the application software today is to provide a standard and/or application-specific firmware upgrade to the embedded networking device. However, during the upgrade/update to the firmware to the NIC, for example, the applications for packet processing may need to be interrupted or paused, and following the firmware upgrade/update, the multi-core packet processing engine of the NIC needs to restart and to initialize all the applications running on it. Due to the high volume of packets processed by the applications running on the multi-core packet processing engine, frequent application interruption and restart caused by firmware upgrade/update to the NIC would cause serious interruption to packet processing by the applications and proper functioning of the embedded networking device. It is thus desirable to be able to update/upgrade the firmware of the embedded networking devices live without interrupting the applications running on it.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a system configured to support live upgrade and update of firmware on an embedded networking device in accordance with some embodiments.

FIG. 2 depicts a flowchart of an example of a process to support live upgrade and update of firmware on an embedded networking device in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support performing a live update or upgrade of a firmware of an embedded networking device, e.g., a Network Interface Card (NIC), to a successful completion without resetting the embedded networking device. For the live update or upgrade to the firmware of the embedded networking device, a new version of the firmware that includes new features/enhancements to improve the product functionality or fix bugs encountered in previous versions of the firmware is installed seamlessly on the embedded networking device to replace the current version of the firmware on one or more cores at a time. During the live firmware updating or upgrading process, various software applications running on other cores of the embedded networking device continue to perform packet processing operations without any interruption. The live firmware update process continues until all cores of the embedded networking device are updated with the newly updated/upgraded firmware.

By enabling live firmware update or upgrade to the embedded networking device, the proposed approach allows flexible packet processing capabilities of the applications without experiencing any down-time on the embedded networking device deployed in, e.g., a cloud-based data center. The firmware updating or upgrading process is transparent to the applications running on the embedded networking device, wherein the applications running on at least some cores of the embedded networking device continue to perform packet processing operations without interruption. The entire firmware updating or upgrading process can be accomplished in a short period of time, typically in a couple of seconds.

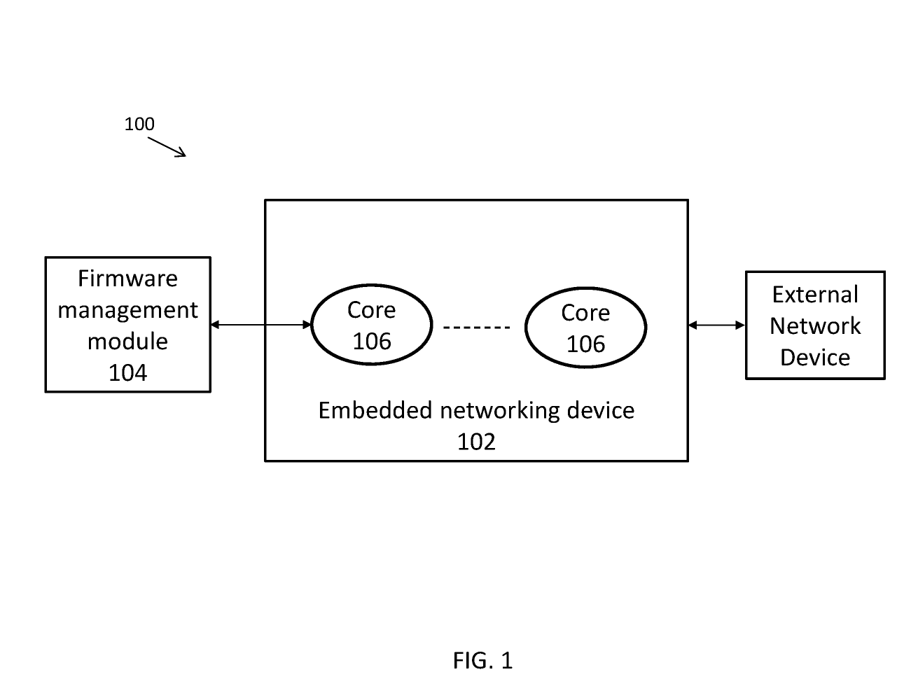

FIG. 1 depicts an example of a diagram of a system 100 configured to support live upgrade and update of firmware on an embedded networking device. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a hardware-based, software-programmable embedded networking device 102. Here, the embedded networking device 102 can be a multi-core embedded hardware module/process engine or a single System-on-Chip (SoC) chip comprising one or more of coprocessors/hardware cores 106, a memory (also referred to as primary memory, not shown) such as RAM, and a storage unit (not shown) such as a non-volatile memory (also referred to as secondary memory) with software instructions stored in for practicing one or more processes. For non-limiting examples, the embedded networking device 102 can be but is not limited to an NIC, and it may be part of OCTEON, x86, and/or ARM based devices/systems/cores/servers.

In some embodiments, a firmware management module 104 is configured to communicate with the embedded networking device 102 to perform live update and/or upgrade of the firmware running on the embedded networking device, In some embodiments, the firmware management module 104 runs on, for non-limiting examples, x86 or ARM based systems/cores/servers. In some embodiments, the firmware management module 104 and the embedded networking device 102 communicate with each other and other devices/hosts/servers over a network (not shown) following certain communication protocols such as TCP/IP protocol. Such network can be but is not limited to, internet, intranet, wide area network (WAN), local area network (LAN), wireless network, Bluetooth, WiFi, mobile communication network, or any other network type. The physical connections of the network and the communication protocols are well known to those of skill in the art. In some alternative embodiments, the firmware management module 104 is configured to run on one of the cores 106 of the embedded networking device 102 and entire system 100 can be in one single SOC chip.

In some embodiments, the embedded networking device 102 is configured to service and offload network packet traffic for an external network device over the network. While the embedded networking device 102 is processing the packet traffic, the firmware management module 104 is configured to support live update and upgrade of the firmware of the embedded networking device 102 by utilizing hot reset features of the driver of the embedded networking device 102 as described below.

In some embodiments, the embedded networking device 102 provides a software development kit (SDK), which is a user-space application control utility that runs on a dedicated core 106 of the embedded networking device 102 running OS (e.g., Linux) and can be utilized by the firmware management module 104 to manage/control hot plug functions, i.e., live update/upgrade of firmware on the embedded networking device 102 and/or loading/unloading of the applications running on all other cores 106 of the embedded networking device 102.

In some embodiments, the firmware management module 104 is configured to perform live update/upgrade to the firmware of the embedded networking device 102 via one of two options—update by compete switch-over or by gradual switch-over.

In some embodiments, to upgrade the firmware of the embedded networking device 102 via a complete switch-over, the firmware management module 104 is configured to shut down applications using the firmware and running on all cores of the embedded networking device 102 using, for a non-limiting example, the following command of the application control utility:

app-ctl shutdown <options> <old_app_file_name>

the firmware management module 104 is then configured to boot up the embedded networking device 102 using the standard bootloader and to start a new firmware on all of the cores of the embedded networking device 102 one single core at a time using, for a non-limiting example, the following command of the application control utility:

app-ctl boot <options> <new_app_file name>

wherein the <options> allow a new firmware to be loaded on one or more cores. Note that the application control utility does not require the bootloader to be involved in this process.

In some embodiments, the firmware management module 104 is configured to notify the application running on the embedded networking device 102 of upcoming firmware update/upgrade and to prepare it for a shutdown when the application control utility shutdown command is issued so that the application stops all of its data/packet processing operations. The application is additionally required to indicate to the driver of the embedded networking device 102 of the scheduled/unscheduled firmware upgrade process and that it is going down so that no further interaction with the external network device happens during the firmware upgrade process. Once the firmware upgrade process is done, the firmware management module 104 is configured to perform a handshake with the driver of the embedded networking device 102 to indicate its “readiness” to resume interaction with the external network device. Although the external network device will not be able to communicate with some of the cores of the embedded networking device 102 during their firmware upgrade process, the amount of time lost in this process or down time can be under a second under ideal conditions.

In some embodiments, the firmware management module 104 is configured to perform an upgrade in a more seamless fashion by switching and updating/upgrading the firmware of the multi-core embedded networking device 102 one core at a time, wherein each core is shut down and a new updated firmware starts on the core in a systematic process. Since the remaining core(s) of the multi-core embedded networking device 102 continue to operate without reset during the firmware update on other cores, such gradual switch-over does not result in any down time of the embedded networking device 102 and the entire firmware upgrade process is performed in a manner that is transparent to the external network device. Specifically, the firmware management module 104 is configured to utilize and call the delete option of the application control utility on all cores 106 but 1 (i.e., n−1 cores) for the existing firmware of the application and starting a new upgraded firmware on those n−1 cores one core at a time. Once all of the n−1 cores have been switched to the new firmware for the application, the main (initial) core using the firmware is shut down and starts with the new upgraded firmware. The following is an example of a code section for gradual firmware switch-over for the embedded networking device 102 having 8 cores running the existing original application:

/* Start the transition to new firmware by taking down one core from old
firmware */
app-ctl delete <old_app> -mask=Ox100 /* remove core 8 of existing
firmware */
app-ctl boot <new_app> -mask=Ox100 /* Start new firmware on core 8*/
/* Note that core 0 would be running linux */
for (core from 7 to 2)
do

app-ctl delete <old_app> -mask=(1<<core)
app-ctl add <new_app> -mask=(1<<core)

done
/* Close the last core for the old firmware and run the new firmware for
the core */
app-ctl shutdown <old_app>
app-ctl add <new_app> -mask=Ox2

As shown in the code section above, one core in the multi-core architecture is dedicated to run Linux, which is an Operating System Kernel. The solution above can be extended to the multi-core embedded networking device 102 with Linux running on an x86 processor and the applications and the firmware update/upgrade capabilities on other Cores of the embedded networking device 102. Note that the Linux core can be replaced by porting the application control utility to run on the x86 processor so that all available cores on multi-core embedded networking device 102 run applications.

In some embodiments, the embedded networking device 102 is configured to support and enable asymmetric multi-core processing, wherein different cores of the embedded networking device 102 may run different applications. In some embodiments, multiple instances of the same application may be running on different cores of the embedded networking device 102, wherein the instances of the same application may share some of their data structures and the cores they are running on may share some common hardware blocks. Here, the hardware blocks can be but are not limited to FPA (Free Pool Unit), PKI (Packet Input Unit), PKO (Packet Output Processing Unit) and SSO (Schedule/Synchronize Order Unit). Under such scenario, when the firmware of a first core running a first instance of the application is being updated, a second instance of the application may continue to run on a second (different) core without interruption. To this end, the live update of the firmware on the first core only affects the core-specific, private data structures not shared between the first and the second instance of the application without touching the shared data structures between the instances. Additionally, the hardware blocks shared between the cores running the instances will not be initialized.

For all of the live firmware update/upgrade approaches discussed above, a new firmware loaded on any of the cores the embedded networking device 102 does not automatically retain the state of the previous version of the firmware. The application needs to be self-aware of the transition and need to make provisions for transferring all relevant information across the update. In some embodiments, when the underlying firmware of a core is to be updated or upgraded, the firmware management module 104 is configured to provision the firmware to check if this is a fresh start or an update and, for the latter case, to avoid re-initializing the hardware blocks and the internal data structures of the core of the embedded networking device 102 so that the previous state of flows and state machines of the embedded networking device can be retained during the firmware update or upgrade on the core.

In some embodiments, the firmware management module 104 is configured to capture the previous state of flows and state machines of the embedded networking device into a known format and storing them in named (memory) blocks that can be retained across updates of the firmware. Here, named blocks allow an application to access data structures preserved in memory just by referring to the label (name) associated with that block. In some embodiments, the application control utility provides named blocks that can be retained across firmware instances, as long as the embedded networking device 102 itself is not reset. An application and its underlying firmware can create multiple named blocks to retain distinct data structures in each of them. Application and its underlying firmware that need data to be carried over from previous invocations should maintain such data in the named blocks and restore them after an update before proceeding with packet/data processing. Here the data to be carried over includes but is not limited to global data structures, flow tables, device configuration and statistics to name a few. Alternately, the firmware management module 104 is configured to transfer the data to be saved to the external network device and have it downloaded after the update/upgrade of the new firmware. Note that transferring data to a new firmware is possible only if the new firmware uses the exact same format for the data structures as the old one. Any transfer of information across firmware that uses different data structures will require import and export routines that handle the conversion in addition to retaining the old firmware's information in named blocks.

It is possible that the new firmware upon execution encounters errors as it starts. Under such circumstances, the new firmware may not be able to continue execution and the firmware management module 104 is configured to decide either to abort the execution of the firmware entirely and reset the system or fall back to using the previous version of the firmware of the application. Note that the latter is possible only if the upgrade is performed one core at a time under the gradual switch-over option, which allows for the old version of the firmware to run on some cores during the upgrade.

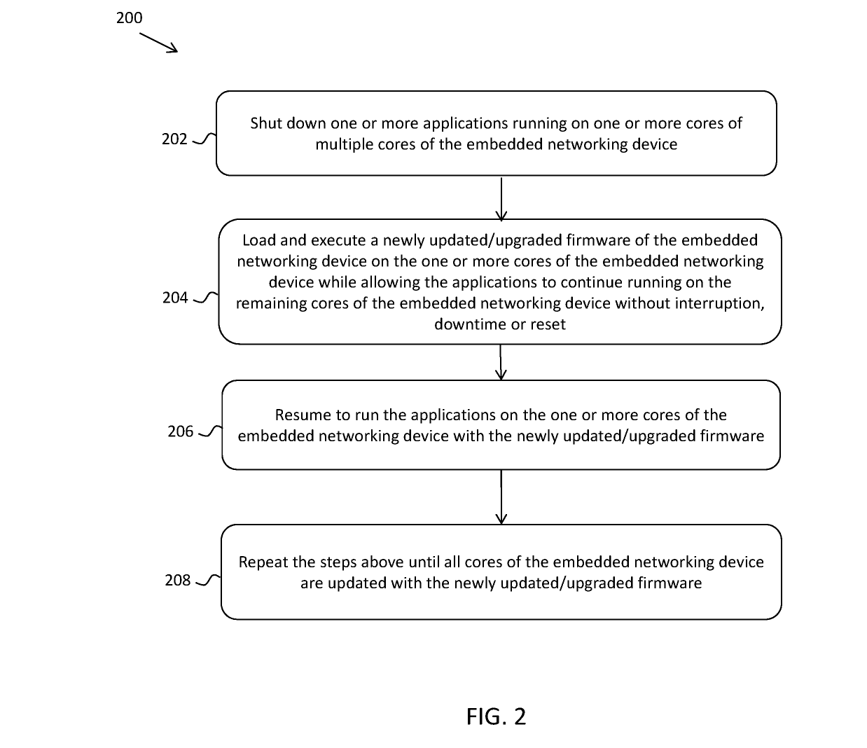

FIG. 2 depicts a flowchart of an example of a process to support live upgrade and update of firmware on an embedded networking device. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202, where one or more applications running on one or more cores of multiple cores of the embedded networking device are shut down. The flowchart 200 continues to block 204, where a new updated/upgraded firmware of the embedded networking device is loaded and executed on the one or more cores of the embedded networking device while allowing the applications to continue running on the remaining cores of the embedded networking device without interruption, downtime or reset. The flowchart 200 continues to block 206, where the applications on the one or more cores of the embedded networking device with the newly updated/upgraded firmware are resumed to running. The flowchart 200 ends at block 208, where the steps above are repeated until all cores of the embedded networking device are updated with the newly updated/upgraded firmware.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support live upgrade and update of firmware on an embedded networking device, comprising:
a firmware controller configured to
shut down one or more applications running on one or more cores of multiple cores of the embedded networking device;
load and execute a newly updated/upgraded firmware of the embedded networking device on the one or more cores of the embedded networking device while allowing the applications to continue running on the remaining cores of the embedded networking device without interruption, downtime or reset;
resume to run the applications on the one or more cores of the embedded networking device with the newly updated/upgraded firmware;
repeat the steps above until all cores of the embedded networking device are updated with the newly updated/upgraded firmware.

2. The system of claim 1, wherein:
the embedded networking device is a Network Interface Card (NIC).

3. The system of claim 1, wherein:
the system is in a single System-on-Chip (SoC) chip.

4. The system of claim 1, wherein:
the embedded networking device is part of one of an OCTEON, x86, and ARM based devices.

5. The system of claim 1, wherein:
the live upgrade and update of firmware to the embedded networking device is transparent to the applications running on the multiple cores of the embedded networking device.

6. The system of claim 1, wherein:
the embedded networking device is configured to service and offload network packet traffic from an external network device.

7. The system of claim 1, wherein:
the firmware controller is configured to perform the live update and upgrade of the firmware of the embedded networking device by utilizing hot reset features of a driver of the embedded networking device.

8. The system of claim 1, wherein:
the firmware controller is configured to perform the live update and upgrade of the firmware of the embedded networking device by utilizing a user-space application control utility that runs on a dedicated core of the embedded networking device.

9. The system of claim 1, wherein:
the firmware controller is configured to perform the live update and upgrade of the firmware of the embedded networking device via a gradual switchover, which shuts down and the application using the firmware and update the new updated firmware on the embedded networking device one core at a time while the remaining core(s) of the embedded networking device continue to operate without reset during the firmware update on other cores.

10. The system of claim 1, wherein:
the embedded networking device is configured to enable asymmetric multi-core processing, wherein different cores of the embedded networking device run different applications.

11. The system of claim 1, wherein:
the firmware controller is configured to enable multiple instances of a same application running on different cores of the embedded networking device, wherein the instances of the same application share some of their data structures and the cores they are running on share some common hardware blocks.

12. The system of claim 11, wherein:
a second instance of the application continues to run on a second (different) core without interruption when the firmware of a first core running a first instance of the application is being updated.

13. The system of claim 12, wherein:
the live update of the firmware on the first core only affects core-specific, private data structures not shared between the first and the second instance of the application without touching the shared data structures between the instances.

14. The system of claim 12, wherein:
the hardware blocks shared between the cores running the instances is not initialized during the live update of the firmware.

15. The system of claim 1, wherein:
the firmware controller is configured to check if the new firmware is a fresh start or an update and, for the latter case, to avoid re-initializing hardware blocks and the internal data structures of the embedded networking device so that previous state of flows and state machines of the embedded networking device are retained during the live update or upgrade of the firmware.

16. The system of claim 15, wherein:
the firmware controller is configured to capture the previous state of flows and state machines into a known format and store them in memory blocks to be retained across updates of the firmware.

17. The system of claim 16, wherein:
The memory blocks are named blocks, wherein each named block allows the application to access the data structures preserved in memory just by referring to a label/name associated with that block.

18. The system of claim 16, wherein:
the firmware controller is configured to capture the previous state of flows and state machines and transfer data to be saved and to have it downloaded after the update/upgrade of the firmware.

19. The system of claim 1, wherein:
the firmware controller is configured to decide either to abort executing the newly updated/upgraded firmware entirely and reset the system or fall back to using the previous version of the firmware of the application when the newly updated/upgraded firmware is not able to continue execution on the embedded networking device.

20. A method to support live upgrade and update of firmware on an embedded networking device, comprising:
shutting down one or more applications running on one or more cores of multiple cores of the embedded networking device;
loading and executing a new updated/upgraded firmware of the embedded networking device on the one or more cores of the embedded networking device while allowing the applications to continue running on the remaining cores of the embedded networking device without interruption, downtime or reset;
resuming to run the applications on the one or more cores of the embedded networking device with the newly updated/upgraded firmware;
repeating the steps above until all cores of the embedded networking device are updated with the newly updated/upgraded firmware.

21. The method of claim 20, further comprising:
servicing and offloading network packet traffic from an external network device.

22. The method of claim 20, further comprising:
performing the live update and upgrade of the firmware of the embedded networking device by utilizing hot reset features of a driver of the embedded networking device.

23. The method of claim 20, further comprising:
performing the live update and upgrade of the firmware of the embedded networking device by utilizing a user-space application control utility that runs on a dedicated core of the embedded networking device.

24. The method of claim 20, further comprising:
performing the live update and upgrade of the firmware of the embedded networking device via a gradual switchover, which shuts down and the application using the firmware and update the new updated firmware on the embedded networking device one core at a time while the remaining core(s) of the embedded networking device continue to operate without reset during the firmware update on other cores.

25. The method of claim 20, further comprising:
enabling asymmetric multi-core processing, wherein different cores of the embedded networking device run different applications.

26. The method of claim 20, further comprising:
enabling multiple instances of a same application running on different cores of the embedded networking device, wherein the instances of the same application share some of their data structures and the cores they are running on share some common hardware blocks.

27. The method of claim 26, further comprising:
continuing to run a second instance of the application on a second (different) core without interruption when the firmware of a first core running a first instance of the application is being updated.

28. The method of claim 27, wherein:
the live update of the firmware on the first core only affects core-specific, private data structures not shared between the first and the second instance of the application without touching the shared data structures between the instances.

29. The method of claim 27, wherein:
the hardware blocks shared between the cores running the instances is not initialized during the live update of the firmware.

30. The method of claim 20, further comprising:
checking if the new firmware is a fresh start or an update and, for the latter case, to avoid re-initializing hardware blocks and the internal data structures of the embedded networking device so that previous state of flows and state machines of the embedded networking device are retained during the live update or upgrade of the firmware.

31. The method of claim 30, further comprising:
capturing the previous state of flows and state machines into a known format and store them in memory blocks to be retained across updates of the firmware.

32. The method of claim 31, further comprising:
capturing the previous state of flows and state machines and transfer data to be saved and to have it downloaded after the update/upgrade of the firmware.

33. The method of claim 20, further comprising:
deciding either to abort executing the newly updated/upgraded firmware entirely and reset the system or fall back to using the previous version of the firmware of the application when the newly updated/upgraded firmware is not able to continue execution on the embedded networking device.
